(19) United States
(12) Patent Application Publication
(10) Pub. No.: US 2011/0143784 A1
(43) Pub. Date: Jun. 16, 2011

(54) System and Method for Indicating Multiple Destination Addresses in a Message

(76) Inventor: Inderpreet Singh Ahluwalia, Austin, TX (US)

(21) Appl. No.: 12/637,360

(22) Filed: Dec. 14, 2009

(51) Int. Cl. H04W 4/12

(52) U.S. Cl. 455/466

(57) ABSTRACT

Described herein are systems and methods for indicating multiple destination addresses in a Short Message Service (“SMS”) message. One embodiment of the disclosure of this application is related to a method comprising receiving a short message service (“SMS”) message from an originator, the SMS message including a plurality of recipient address identifying a plurality of recipients, generating a destination message of the SMS message for each of the plurality of recipients, and transmitting each of the destination messages to a respective recipient, each destination message including an originator address and the destination address of at least one other recipient

### BACKGROUND

Short Message Service (“SMS”), or “text messaging,” may be described as a communication service standardized in the Global System for Mobile Communications (“GSM”). Specifically, standardized communications protocols may be utilized in exchanging short text messages between mobile telephone devices, such as cellular telephone, personal digital assistants (“PDAs”), etc. SMS messaging is the most widely used data application on the planet, having 2.4 billion active users, or 74% of all mobile phone subscribers, sending and receiving text messages on their phones. Accordingly, the SMS technology has facilitated the development and growth of text messaging.

Multimedia Messaging Service (“MMS”) may be described as a standardized service for sending messages that include multimedia content to and from mobile devices. MMS technology extends the core SMS capabilities, since it expands the size and type of data exchanged between mobile devices. For example, the MMS service allows a user to send photographs from mobile devices such as camera-equipped handsets. In addition, MMS service is also popular as a method of delivering news and entertainment content including videos, pictures, text-base web pages, ringtones, etc.

Today, when an SMS message is to be sent to a group of recipients, the user creates a single message that is addressed to multiple destination addresses, and the device originates multiple messages (i.e., one to each destination address). Unlike electronic mail (“email”) or MMS, the SMS feature does not explicitly support the transmission of a single SMS message to multiple destination addresses. Furthermore, the SMS feature does not support informing the recipient that the message was transmitted to multiple recipients, or the destination addresses of the other recipients. In other words, each recipient receives a message, but there is no indication that the message had, in fact, been transmitted to at least one other address. Accordingly, when the recipient wishes to respond to the message, he is only able to reply to the sender (i.e., the originator of the original message).

### SUMMARY OF THE INVENTION

Described herein are systems and methods for indicating multiple destination addresses in a Short Message Service (“SMS”) message. One embodiment of the disclosure of this application is related to a method comprising receiving a short message service (“SMS”) message from an originator, the SMS message including a plurality of recipient address identifying a plurality of recipients, generating a destination message of the SMS message for each of the plurality of recipients, and transmitting each of the destination messages to a respective recipient, each destination message including an originator address and the destination address of at least one other recipient

A further embodiment of the disclosure of this application is related to a system comprising a server receiving multiple short message service (“SMS”) messages from an originator, each of the multiple SMS messages including a plurality of recipient addresses identifying a plurality of recipients, the server generating a destination message for each of the plurality of recipients of the SMS messages, and a transmitter transmitting, from the server, each of the destination messages to a respective recipient, each destination message including an originator address and the destination address of at least one other recipient.

A further embodiment of the disclosure of this application is related to a computer readable storage medium including a set of instructions that are executable by a processor. The set of instructions being operable to receive a short message service (“SMS”) message from an originator, the SMS message including a plurality of recipient address identifying a plurality of recipients, generate a destination message of the SMS message for each of the plurality of recipients, and transmit each of the destination messages to a respective recipient, each destination message including an originator address and the destination address of at least one other recipient.

### BRIEF DESCRIPTION OF THE DRAWINGS

FIG. 1 shows an exemplary system for including multiple destination addresses in a mobile-originating (“MO”) SMS message according to an exemplary embodiment.

FIG. 2 shows an exemplary method for including multiple destination addresses in a mobile-originating (“MO”) SMS message according to an exemplary embodiment.

FIG. 3 shows an exemplary layout for an exemplary SMS message including the TP-User-Data-Length (“UDL”) and TP-User-Data (“TP-UD”) for uncompressed GSM 7-bit default alphabet data according to an exemplary embodiment described herein.

FIG. 4 shows a table defining the coding of multiple destination address Information Elements (“IE”) according to the exemplary embodiments described herein.

FIG. 5 shows an exemplary layout for an exemplary mobile-originating (“MO”) SMS message destined to three different recipients, formatted for SMS-SUBMIT according to an exemplary embodiment described herein.

FIG. 6 shows an exemplary layout for an exemplary mobile-terminating (“MT”) SMS message received at one of the recipients, formatted for SMS-DELIVER according to an exemplary embodiment described herein.

### DETAILED DESCRIPTION

The exemplary embodiments may be further understood with reference to the following description and the related appended drawings, wherein like elements are provided with the same reference numerals. The exemplary embodiments are related to systems and methods for transmitting messages between multiple communication devices, such as mobile telecommunication devices. Specifically, the exemplary embodiments described herein relate to systems and methods for including multiple destination addresses in a mobile-originating (“MO”) Short Message Service (“SMS”) message. In addition, the exemplary systems and methods may provide for a mobile-terminating (“MT”) SMS message indicating that it was sent to multiple destination addresses. Furthermore, the exemplary systems and methods may allow for each of the message recipients to reply to the sender, one or more of the other recipients, or any combination thereof.

It should be noted that one possible, but less that satisfactory, solution may be to convert a MO-SMS message into a MO-MMS message, or an email, when the user has more than one destination addresses. Multimedia Messaging Service (“MMS”) is a standardized service for sending messages that include multimedia content to and from mobile devices. Accordingly, MO-MMS messages expand the size and type of data exchanged between mobile devices. As noted above, both email and MMS functionalities allow for multiple recipients to be informed of the other message recipients. In order for an MO-MMS message to be delivered to a user, a Short Message Service Center (“SMS-C”) may send an MMS Push message to a receiving entity. This receiving entity directs the receiving terminal to connect to a Multimedia Message Service Center (“MMS-C”) to download the now-converted MMS message.

Accordingly, each of the recipients may then receive an MMS message, or email, instead of the original SMS message. Thus, the user may then use a “reply to sender” or “reply to all” feature, or even select one or more specific recipients to reply to. In any event, the recipient may only be able to respond to any of the parties via an MMS message or an email. As will be described in detail below, the exemplary embodiments may avoid any conversion process and allow for the recipient to any of the sender and other recipients via SMS message. Also, if the receiving entity did not have a unified inbox (e.g., an inbox receiving both SMS and MMS messages), then some messages would only be available in the SMS inbox while other messages would either unavailable or only be available in the MMS/email inbox. By using only SMS, all messages will be available to the user via the SMS inbox. Thus, the usability of the SMS features may be greatly increased.

While the exemplary embodiments described herein may refer to systems and methods within a Global System for Mobile Communications (“GSM”) network, it should be noted that these exemplary embodiments is applicable to any number of communication networks. For instance, the systems and methods described herein may also be applied within, but not limited to, Universal Mobile Telecommunications System (“UMTS”) networks, GSM/UMTS networks, Long Term Evolution (“LTE”) networks, Code Division Multiple Access (“CDMA”) networks, any combination thereof, etc.

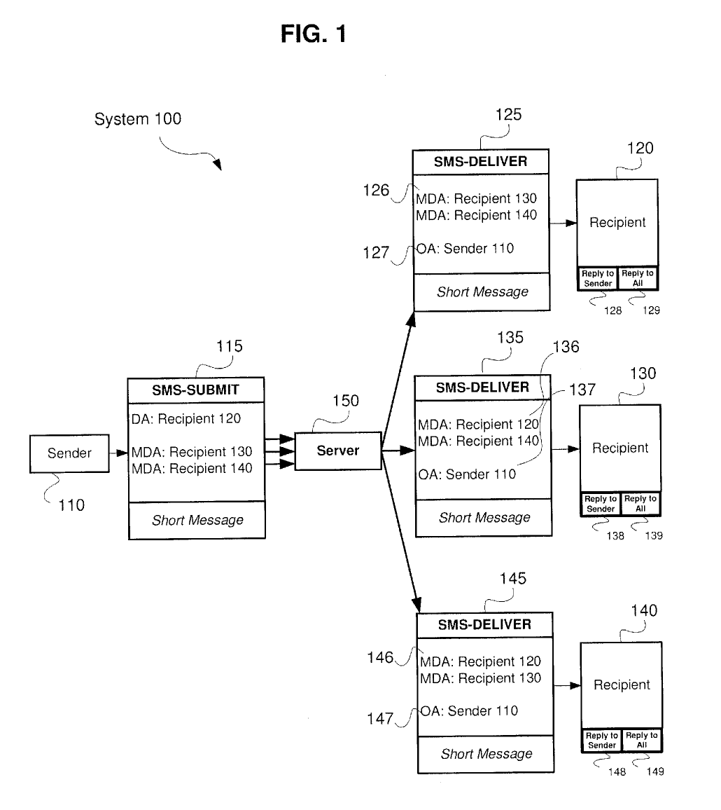

FIG. 1 shows an exemplary system 100 for including multiple destination addresses in a mobile-originating (“MO”) SMS message according to an exemplary embodiment. The exemplary system 100 may include a first recipient 120 and multiple recipients 130-140 via a network server 150, such as an SMS-C. According to the exemplary system 100, each of the sender 110 and the recipients may be one of any number of mobile communication devices capable of SMS communications, such as for example, cellular telephones, PDAs, portable computers, etc. The exemplary sever 150 and the mobile computing devices may each include a processor as well as a computer readable storage medium (e.g., a memory) including a set of instructions that are executable by the respective processors.

The outgoing message 115 from the sender 110 may be received by the server 150 as three SMS-SUMBIT messages, wherein each of the SMS-SUMBIT messages includes three destination addresses (e.g., the addresses of recipients 120-140). The server 150 may then transmit three separate SMS-DELIVERY messages to each of the recipients 120-140 as incoming messages 125-145, respectively. According to the exemplary embodiments described herein, the system 100 may allow for each of the recipients 120-140 to be informed of the other recipients of the outgoing message 115. In other words, the incoming message 125 of recipient 120 may provide a sender indication 126 identifying the sender 110 as the originator of the message 125. The incoming message 125 may also provide one or more recipient indications 127 identifying one or more other recipients of the message 125 (e.g., recipients 130 and 140). Accordingly, each of the other recipients 130 and 140 may receive similar sender indications 136 and 146 and recipient indications 137 and 147 within their respective incoming messages 135 and 145.

It should also be noted that the system 100 may allow for each of the recipients 120-140 to reply to the sender 110, to one or more of the other recipients 120-140, or any combination thereof. For example, the incoming message 120 may include a feature to reply to only the sender 110, such as a “Reply to Sender” button 128. In addition, the incoming message 120 may include a feature to reply to the sender 110 and the other recipients 130 and 140, such as a “Reply to All” button 129. These features may allow the recipient 120 to initiate a new message (e.g., an SMS message) in response to the original incoming message 120 from the sender 110.

The exemplary system 100 enables the use of group-SMS messaging (e.g., “mass texting”) in a more usable manner. Compared to the other solution discussed above that converts SMS messages into MMS messages or email, the system 100 may be less data intensive. As detailed above, in order for an MMS message is delivered to a user, a Short Message Service Center (“SMS-C”) sends an MMS Push message to a receiving entity. This receiving entity directs the receiving terminal to connect to a Multimedia Message Service Center (“MMS-C”) to download the now-converted MMS message. In contrast, the system 100 uses SMS messages on the originating end as well as on the terminating end and does not require any data connection or message conversion. Thus, this system 100 is more cost effective towards a network signaling resource. Furthermore, if the receiving entity did not have a unified inbox (e.g., an inbox receiving both SMS and MMS messages), then some messages would only be available in the SMS inbox while other messages would only be available in the MMS inbox, or email inbox. By using only SMS, all messages will be available to the user via the SMS inbox. Thus, the usability of the SMS features may be greatly increased.

While FIG. 1 describes the message as mobile-originating, as well as each of the originating device and the destination devices as mobile devices, it should be noted that the exemplary embodiments of the system is not limited to mobile devices. Specifically, SMS communication technology is not limited to mobile devices. Therefore, the SMS messages described herein may originate from either a mobile device or fixed computing device, such as desktop computer, etc.

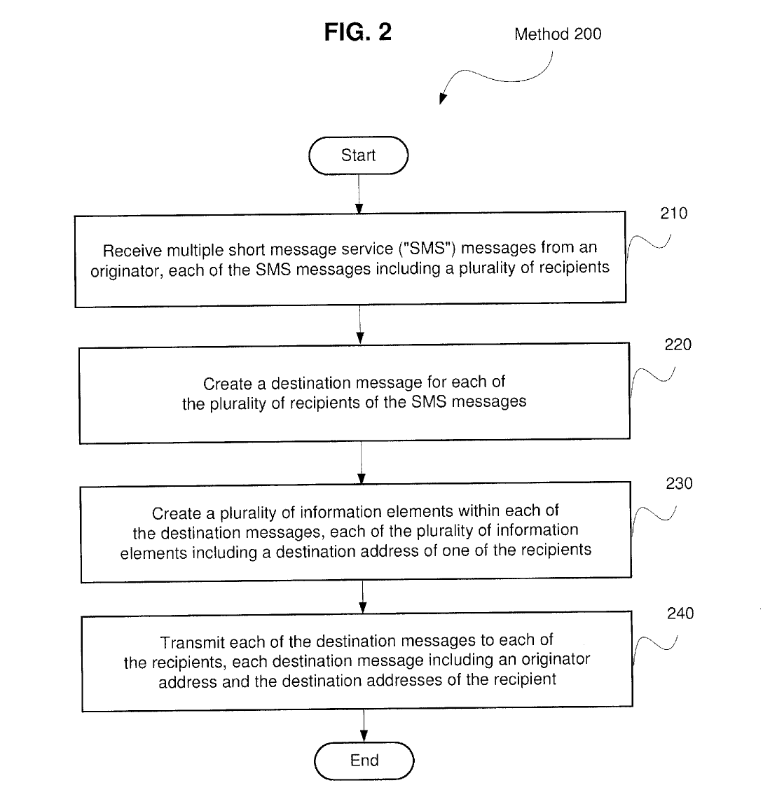

FIG. 2 shows an exemplary method 200 for including multiple destination addresses in a mobile-originating (“MO”) SMS message according to an exemplary embodiment. The method 200 will be discussed with reference to the system 100 and the exemplary components FIG. 1.

In step 210, the server 150 may receive multiple short message service (“SMS”) messages 115 from an originator (e.g., three SMS-SUBMIT messages) wherein the SMS message including a plurality of recipients (e.g., recipients 120-140). Specifically, each of the SMS messages may contain the originator's address 110 as well as a plurality of destination addresses corresponding to the recipients.

In step 220, the server 150 may create a plurality of destination messages 125-145 (e.g., SMS-DELIVER messages) for each of the recipients listed the received SMS messages 115. In other words, a destination SMS message (e.g., message 125-145) may be prepared for transmission to each of the recipients 120-140 listed in the multiple SMS messages 115.

In step 230, the server 150 may generate a plurality of information elements (“IEs”) within each of the destination messages, each of the plurality of information elements including a destination address of one of the recipients. Specifically, the IE may be defined as “MULTIPLE DESTINATION ADDRESS” objects within the SMS message. Therefore, data related to each of the destination addresses may be added into one of the created “MULTIPLE DESTINATION ADDRESS” objects.

In step 240, the server 150 may transmit each of the destination messages to each of the recipients, each destination message including an originator address and the destination addresses of the recipient. Specifically, the destination message received by each recipient may contain the originators address in the TP-OA field and the remaining recipients are indicated in each of the “MULTIPLE DESTINATION ADDRESS” object fields. By using this information, it may be possible for each of the recipients to reply to either the sender (e.g., the TP-OA) or all recipients (e.g., TP-OA and each of the Multiple Destination Addresses) or select individuals (e.g., TP-OA or any of the Multiple Destination Addresses) or to any combination thereof.

Within the realm of mobile communications, the 3rd Generation Partnership Project (“3GPP”) was formed between groups of telecommunications associations in order to globally standardize third generation (“3G”) mobile phone system specifications. Specifically, 3GPP specifications are based on evolved Global System for Mobile Communications (“GSM”) specifications. Protocols utilizing SMS functionality may be defined by 3GPP TS 23.040 for the “Short Message Service: Point-to-Point (SMS-PP)”.

Accordingly, the 3GPP TS defines a mechanism of using User Data Header (“UDH”) information in the transmission path user data (“TP-User Data”) portion of the SMS message. By using 3GPP standardized tags, the UDH mechanism may allow for the specification of items such as concatenated messages, application port addresses, voicemail indications, etc. As will be described below, an additional UDH tag may be defined to include each of the destination addresses of the SMS message. For example, a UDH tag entitled “MULTIPLE DESTINATION ADDRESS” may include each destination address as the value part of each type-length-value (“TLV”) object of the message. In other words, the “MULTIPLE DESTINATION ADDRESS” may serve as an additional Information Element (“IE”) of the SMS message. Therefore, it would be possible to include multiple destination addresses in a single MO-SMS message.

According to the exemplary embodiment defined herein, a mobile device, such as the sender 110 using an SMS-capable cellular phone, may originate a single SMS message (e.g., outgoing message 115) per destination address. However, each of the recipients 120-140 may now receive a UDH object entitled, “MULTIPLE DESTINATION ADDRESS”. This may inform each of the recipients 120-140 of one another. Therefore, through the use of an appropriate user interface on the SMS-capable device, the recipients 120-140 are able to reply to the sender 110, all of the recipients 120-140, or a select group of the sender 110 and/or the recipients 120-140.

In the originating message 115, the destination address (“TP-DA”) may be used to indicate the first destination address. The remaining destination addresses may be indicated in each of the “MULTIPLE DESTINATION ADDRESS” fields. At a receiving entity, such as recipient 120, the incoming message 125 may contain the originator address in the TP-OA field and the remaining recipients 130 and 140 may be indicated in each of the “MULTIPLE DESTINATION ADDRESS” fields. Therefore, by using this information, it is possible to reply to: the sender 110 (e.g., via the TP-OA); or the sender 110 and all other recipients 130 and 140 (e.g., via the TP-OA and each of the “MULTIPLE DESTINATION ADDRESS” fields); or selected individuals (e.g., via the TP-OA and/or any number of the “MULTIPLE DESTINATION ADDRESS” fields).

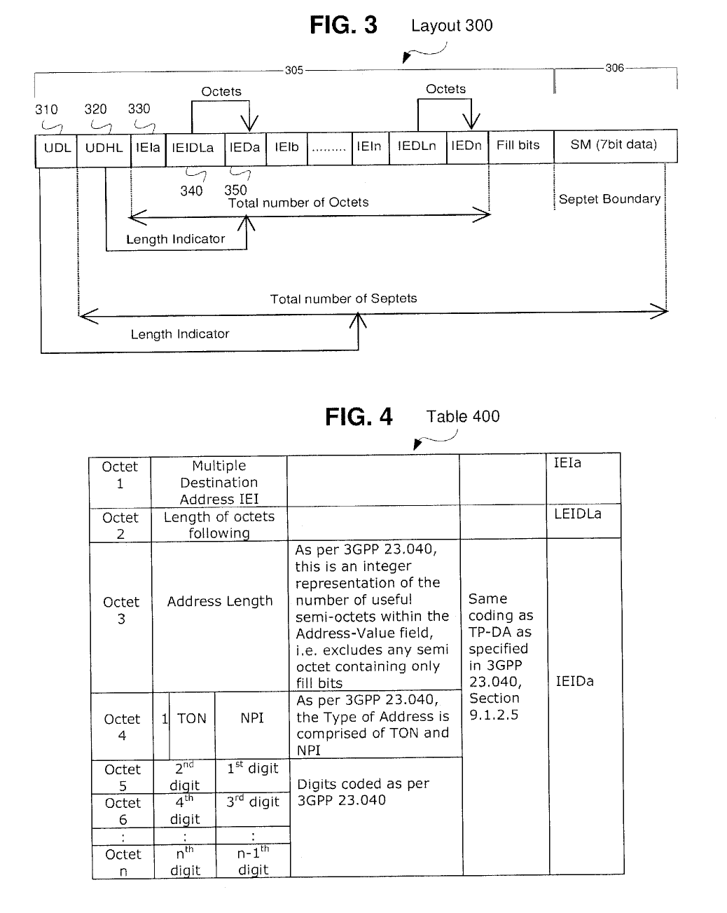

FIG. 3 shows an exemplary layout 300 for an exemplary SMS message including the TP-User-Data-Length (“UDL”) and TP-User-Data (“TP-UD”) for uncompressed GSM 7-bit default alphabet data according to an exemplary embodiment described herein. The layout 300 of the SMS message may include a number of fields 305 as well as a short message 360 (e.g., 7-bit data). While FIG. 3 describes the SMS message including uncompressed GSM 7-bit data, it should be noted that the exemplary embodiments of the system is not limited to any data format. For instance, the SMS message may be formatted in uncompressed 8-but data, or any other format.

The UDL field 310 may define the number of septets in the total message (e.g., the septets in the TP-User-Data). The User-Data-Header-Length (“UDHL”) field 320 is the first octet of the TP-User-Data content of the SMS message 300. Accordingly, the UDHL field 320 may define the number of octets in the User Data Header, not including itself. The IEIa field 330 is the Information Element Identifier for a first element (e.g., element “IEIa”), as coded in 3GPP TS 23.040, §9.2.3.24. Accordingly, the IEIDLa field 340 may define the length in octets of the data associated with IEIa and IEIDa 350 may define the data associated with IEIa. It should be noted that, as illustrated in the layout 300 of FIG. 3, additional elements (e.g., “b”, . . . “n”, etc.) may be defined in the same manner (e.g., IEIb, . . . IEIn, etc.).

FIG. 4 shows a table 400 defining the coding of “MULTIPLE DESTINATION ADDRESS” Information Elements (“IE”), according to the exemplary embodiments described herein. Specifically, the exemplary table defines each of the octets (e.g., Octet 1 thru Octet n) within the “MULTIPLE DESTINATION ADDRESS” object.

For instance, as illustrated in the table 400, Octet 1 may include the Information Element Identifier (“IEIa”) of “Multiple Destination Address IEI”. Octet 2 may include the length in octets, IEIDLa, of the data associated with the IEIa. Octet 3 may include the address length. The address length may be an integer representation of the number of useful semi-octets within the Address-Value field (e.g., excluding any semi-octets containing only “fill bits”). Octet 4 may include type of numbering (“TON”) and numbering plan indicator (“NPI”) information. The remaining octets may include digits coded as per 3GPP 23.040.

It should be noted that the 3GPP specification allows for certain IEs to be repeated with a single short message, or within a concatenated message. Therefore, according to the exemplary embodiments described herein, any number of “Multiple Destination Address IEs” may be included within the message while still maintaining compliance within the 3GPP criteria.

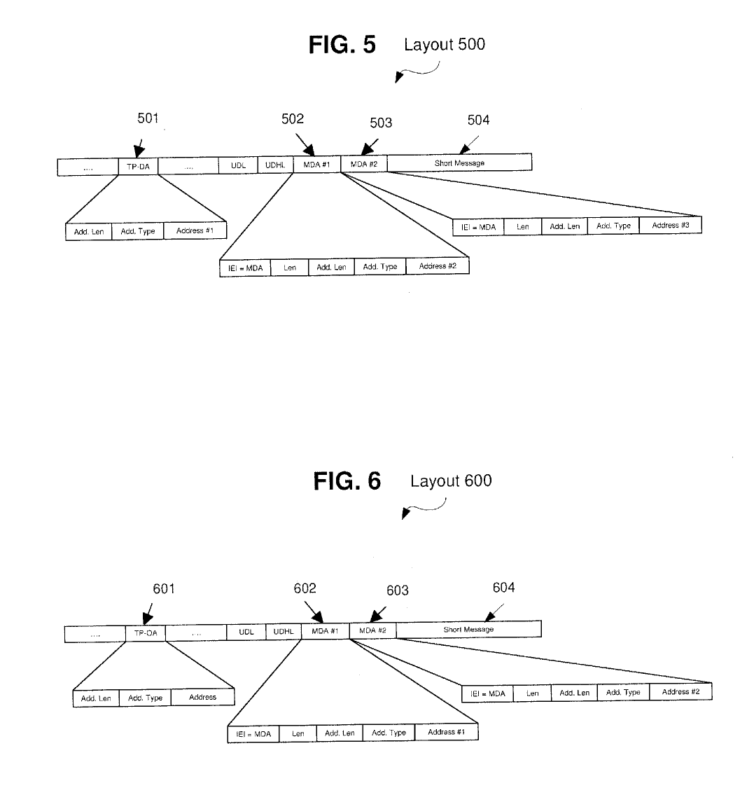

FIG. 5 shows an exemplary layout 500 for an exemplary mobile-originating (“MO”) SMS message destined to three different recipients, formatted for SMS-SUBMIT according to an exemplary embodiment described herein. The layout 500 for the MO-SMS message will be discussed with reference to the outgoing message 115 and the exemplary components of the system 100 of FIG. 1.

As illustrated in FIG. 5, a first IE, titled TP-DA 501, may contain the destination address of the first recipient 120. For instance, the TP-DA 501 may include address length, address type, and address value (e.g., address #1) for recipient 120. An additional IE titled MDA #1 502 may contain the destination address of the second recipient 130. For instance, the MDA #1 502 may include IEI of “MDA”, IEIDL, address length, address type, and address value (e.g., address #2) for recipient 130. Furthermore, an additional IE titled MDA #2 503 may contain the destination address of the third recipient 130. For instance, the MDA #2 503 may include IEI of “MDA”, IEIDL, address length, address type, and address value (e.g., address #3) for recipient 140. Accordingly, additional IEs may be included to indicate further recipients. Furthermore, a short message 504 may follow all of the IEs.

FIG. 6 shows an exemplary layout 600 for an exemplary mobile-terminating (“MT”) SMS message received at one of the recipients, formatted for SMS-DELIVER according to an exemplary embodiment described herein. The layout 600 for the MT-SMS message will be discussed with reference to the incoming message 125 and the exemplary components of the system 100 of FIG. 1.

As illustrated in FIG. 6, a first IE, titled TP-OA 601, may contain the originator address of the sender 110. For instance, the TP-OA 601 may include address length, address type, and address value (e.g., origin address) for the sender 110. An additional IE titled MDA #1 602 may contain the destination address of the first recipient 120. For instance, the MDA #1 602 may include IEI of “MDA”, IEIDL, address length, address type, and address value (e.g., address #1) for recipient 120. Furthermore, an additional IE titled MDA #2 603 may contain the destination address of the second recipient 130. For instance, the MDA #2 603 may include IEI of “MDA”, IEIDL, address length, address type, and address value (e.g., address #3) for recipient 130. Accordingly, additional IEs may be included to indicate further recipients. Furthermore, a short message 604 may follow all of the IEs.

It should be noted that it is possible that the include of multiple recipients in the “MULTIPLE DESTINATION ADDRESS” field, along with the actual short text message, may result in the message length exceeding the 140-byte limit of the TP-UD. Accordingly, this may cause the message to become a concatenated message, in which the use of the CONCATENATED SMS IEI may also need to be included in the message. The use of multiple IE's being included in the UDH is already supported by the 3GPP specification.

The specification also states that a terminal (e.g., recipient mobile device) receiving any IE that is “reserved” or “not supported” may ignore the IE. In other words, the terminal may skip over the data of the IE and commence processing at the next information element. In this case, a message sent to a recipient whose terminal does not support the Multiple Destination Address IEI may simply ignore this information. Accordingly, the recipient would be unaware that this message was sent to more than one destination addresses.

It will be apparent to those skilled in the art that various modifications may be made in the described embodiments, without departing from the spirit or the scope of the application. Thus, it is intended that the present disclosure covers modifications and variations of this application provided they come within the scope of the appended claimed and their equivalents.

1. A method, comprising:
receiving a short message service (“SMS”) message from an originator, the SMS message including a plurality of recipient addresses identifying a plurality of recipients;
generating a destination message of the SMS message for each of the plurality of recipients, wherein each of the destination messages includes a plurality of information elements, each of the plurality of information elements including a destination address of one of the recipients; and
transmitting each of the destination messages to a respective recipient, each destination message including an originator address and the destination address of at least one other recipient.

2. (canceled)

3. The method according to claim 1, further including:
formatting each of the destination messages to indicate the destination addresses to the recipients.

4. The method according to claim 1, wherein each of the information elements is generated within a user data header of the SMS message.

5. The method according to claim 1, wherein each of the information elements includes a multiple destination address field.

6. The method according to claim 5, wherein each of the multiple destination address fields includes a data length, a data type, and a value associated with the destination address of one of the recipients.

7. The method according to claim 1, wherein each of the SMS messages is received from a mobile communication device.

8. A system, comprising:
a server receiving multiple short message service (“SMS”) messages from an originator, each of the multiple SMS messages including a plurality of recipient addresses identifying a plurality of recipients, the server generating a destination message for each of the plurality of recipients of the SMS messages, wherein each of the destination messages includes a plurality of information elements, each of the plurality of information elements including a destination address of one of the recipients; and
a transmitter transmitting, from the server, each of the destination messages to a respective recipient, each destination message including an originator address and the destination address of at least one other recipient.

9. (canceled)

10. The system according to claim 8, further including:
a data formatter formatting each of the destination messages to indicate the destination addresses to the recipients.

11. The system according to claim 8, wherein each of the information elements is generated within a user data header of the SMS message.

12. The system according to claim 8, wherein each of the information elements includes a multiple destination address field.

13. The system according to claim 12, wherein each of the multiple destination address fields includes a data length, a data type, and a value associated with the destination address of one of the recipients.

14. The system according to claim 8, wherein each of the SMS messages is received from a mobile communication device.

15. A non-transitory computer readable storage medium including a set of instructions that are executable by a processor, the set of instructions being operable to:
receive a short message service (“SMS”) message from an originator, the SMS message including a plurality of recipient addresses identifying a plurality of recipients;
generate a destination message of the SMS message for each of the plurality of recipients, wherein each of the destination messages includes a plurality of information elements, each of the plurality of information elements including a destination address of one of the recipients; and
transmit each of the destination messages to a respective recipient, each destination message including an originator address and the destination address of at least one other recipient.

16. (canceled)

17. The computer readable storage medium according to claim 15, wherein the set of instructions are further operable to:
format each of the destination messages to indicate the destination addresses to the recipients.

18. The computer readable storage medium according to claim 15, wherein each of the information elements is generated within a user data header of the SMS message.

19. The computer readable storage medium according to claim 15, wherein each of the information elements includes a multiple destination address field.

20. The computer readable storage medium according to claim 19, wherein each of the multiple destination address fields includes a data length, a data type, and a value associated with the destination address of one of the recipients.
